(19) United States
(12) Patent Application Publication
(10) Pub. No.: US 2022/0304211 A1
(43) Pub. Date: Sep. 29, 2022

(54) IMPROVED HEAD FOR AN AGRICULTURAL TOOL

(71) Applicant: CRAIL BRAE PTY LTD, Port Lincoln, South Australia (AU)

(72) Inventor: Nigel Eckermann, Port Lincoln, South Australia (AU)

(21) Appl. No.: 17/597,164

(22) PCT Filed: Jun. 26, 2020
(86) PCT No.: PCT/AU2020/050654

§ 371 Date: Dec. 28, 2021

(30) Foreign Application Priority Data
Jun. 28, 2019 (AU) 2019902300

(51) Int. Cl. A01B 39/22; A01B 35/24; A01B 49/06; A01B 63/00; A01B 63/24

(52) U.S. Cl. CPC A01B 39/22; A01B 35/24; A01B 49/06; A01B 63/002; A01B 63/24

(57) ABSTRACT

The present invention relates to a head for attaching an agricultural tool to a support beam configured to be towed along a longitudinal axis, the support beam extending substantially transversely to the longitudinal axis, said head including a mounting bracket assembly configured to mount to the support beam at a location along a length of the support beam, and enable attachment of the agricultural tool such that the agricultural tool, when attached, suspends from the clamped mounting bracket assembly, the mounting bracket assembly being mountable to the support beam such that a tool attachment portion of the mounting bracket assembly is forwardly disposed, enabling the agricultural tool to be attached at a fore or central position along the longitudinal axis relative to the transverse support beam, or rearwardly disposed, enabling the agricultural tool to be attached at the central or an aft position along the longitudinal axis relative to the transverse support beam.

### FIELD OF THE INVENTION

The present invention relates to an improved head for an agricultural tool and, in particular, a head for attaching a plurality of different agricultural tools, such as a soil cultivation (including tilling, seeding and fertilizing tools for example), to a self-propelled machine and/or a towed implement associated with a frame of a self-propelled agricultural machine. The head is configured to mount to a support beam to enable attachment of the head in one of a plurality of different locations and configurations. The invention further relates to a support beam with a plurality of heads attached, in a configuration that enables a single row, two row or three row tool arrangement, wherein the number of rows is selected based upon the particular farming requirement. The invention further relates to a self-propelled agricultural machine including one or more of such support beams.

### BACKGROUND OF THE INVENTION

The majority of farmers grow their crops on a broad-acre level. This is common in Australia, for example, and involves planting crops on a large scale within a limited time frame. The growth of farming in Australia and economies of scale has resulted in farmers increasing their landholdings in order to remain viable, and therefore, efficient and productive farming is imperative. As farms become larger and spread over larger distances, the variables for the farmer increase even more. The type of soil into which the farmer sows may vary from sticky clay to non-wetting sand, from abrasive ironstone to soft loamy soils. The amount of rainfall from one property to the next may also vary dramatically. The style of farming required from one farm to the next may also be very different.

For example, on one farm, a farmer might graze stock which can result in compacted soil. Another farm might practice continuous cropping, with crop rotations for each paddock. For example, canola might be grown one year and in the following year, wheat might be grown on the same soil, followed by peas the year after. These three varieties of seed all have a different optimal seeding (or seed placement) depth, hence a single farm can require very different soil cultivation and seeding methods, which currently requires the use of different (often expensive) machinery on the one farm.

Farming practices also change over time and multiple machines are often purchased to suit the changing practices of the farmer. For example, the machines used to place the seed in the ground vary depending on different farming practices. Machines that provide optimal seed placement exist on the market and are effective (for example, there is a separate machine available for each of disc seeding, tine seeding and contour seeding), however, they are typically designed to work in a particular way and in particular conditions. This means that different options are limited within the one machine. Purchasing two or more machines to address different farming methods and different conditions is possible but very cost prohibitive. Generally, the farmer accepts that he or she will sacrifice yields by not having the machinery to work in a variety of conditions.

There is therefore a need for agricultural equipment that is completely adaptable and capable of performing a wide range of seeding functions to suit a variety of farming and environmental conditions, thereby doing away with the need to invest in a plurality of different machines. There is also a need to offer the end user more control over how existing farming equipment can be used, and enables them to optimize performance in accordance with their immediate needs.

The Applicant has also recognized that in seeking to address such problems, it is important to ensure that the agricultural equipment remains user-friendly and does not become too “crowded” with respect to the number and positioning of components to an extent where movement of components during operation is not impeded by obstacles such as structural members, hoses and the like.

There is also a problem associated with existing agricultural equipment that gives rise to the build up of stubble between tines (such as straw stubble that remains in the ground after a particular crop has been harvested). In this regard, existing fixed tine layouts can cause the tines to act like rakes which then start to “bulldoze” the soil. Not only can this compromise the work the machine is trying to perform (e.g. precision seeding), but can also result in machine damage or at least increased wear and tear.

It is an object of the present invention to overcome or at least ameliorate some of the aforementioned problems, or to provide the public with one or more useful alternatives.

### SUMMARY OF THE INVENTION

In one aspect, the present invention provides a head for attaching an agricultural tool to a support beam configured to be towed along a longitudinal axis, the support beam extending substantially transversely to the longitudinal axis, said head including:

a mounting bracket assembly configured to:

mount to the support beam at a location along a length of the support beam, and enable attachment of the agricultural tool such that the agricultural tool, when attached, suspends from the clamped mounting bracket assembly, the mounting bracket assembly being mountable to the support beam such that a tool attachment portion of the mounting bracket assembly is forwardly disposed, enabling the agricultural tool to be attached at a fore or central position along the longitudinal axis relative to the transverse support beam, or rearwardly disposed, enabling the agricultural tool to be attached at the central or an aft position along the longitudinal axis relative to the transverse support beam.

In an embodiment, the support beam includes a first and a second edge substantially along its length and the mounting bracket assembly is configured to engage one or both of the first and second edges, wherein the mounting bracket assembly is configured to clamp the first and/or second edge of the support beam to thereby fix the mounting bracket assembly at said location.

In an embodiment, the support beam includes a horizontal dimension whereby the first edge is a leading edge of the support beam and the second edge is a trailing edge of the support beam. In an alternative embodiment, the support beam includes a vertical dimension whereby the first edge is an upper edge of the support beam and the second edge is a lower edge of the support beam.

In an embodiment, the mounting bracket assembly is configured to clamp one of the leading or trailing edge of the support beam.

In an embodiment, the mounting bracket assembly is configured to clamp both of the leading and trailing edge of the support beam.

In an embodiment, the support beam includes at least one substantially flat panel and the leading edge of the support beam is a front edge of the flat panel and the trailing edge is a rear edge of the flat panel.

In an alternate embodiment, the support beam includes at least one square or rectangular cross section beam and the leading edge of the support beam is a front edge of the square or rectangular cross section beam and the trailing edge of the support beam is a rear edge of the square or rectangular cross section beam.

In an alternate embodiment, the support beam includes at least one circular cross section beam and the leading edge of the support beam is a front portion of the at least one circular cross section beam and the trailing edge of the support beam is a rear portion of the circular cross section beam.

In a further alternate embodiment, the support beam is a truss style beam including a front and a rear beam, where the leading edge of the support beam is a front edge of the front beam and the trailing edge of the support beam is a rear edge of the rear beam.

In an embodiment, the front and rear beams of the truss style beam are of a square, rectangular and/or circular cross section.

In an embodiment, the mounting bracket assembly includes:

a mounting bracket that enables attachment of the agricultural tool and that engages with one of the leading and trailing edges of the support beam, and a clamping bracket that engages with the other of the leading and trailing edges of the support beam to thereby clamp, with the mounting bracket, the leading and trailing edges of the support beam.

In an embodiment, the mounting bracket includes an inverted U-shape along its cross section formed by two spaced apart and substantially vertical wall flange portions and an upper web portion.

In an embodiment, the upper web portion includes a first hook means for engaging with said one of the leading and trailing edges of the support beam, and the clamping bracket includes a second hook means for engaging with said other of the leading and trailing edges of the support beam.

In an embodiment, the first hook means includes two transversely spaced apart slots configured to receive said one of the leading and trailing edges of the support beam.

In an embodiment, the second hook means associated with the clamping bracket includes two transversely spaced apart slots that are longitudinally separated from the spaced apart slots associated with the first hook means and configured to receive said other of the leading and trailing edges of the support beam.

In an embodiment, the mounting bracket is configured such that when the first hook means is engaged with one of the leading or trailing edges of the support beam, the mounting bracket is caused to suspend from and is thereby supported by the support beam to facilitate use of the clamping bracket to engage with the other of the leading and trailing edges of the support beam.

In an embodiment, the upper web element further includes a means of fastening the clamping bracket to the mounting bracket, the fastening means configured such that fastening of the clamping bracket causes the clamping bracket and hence the second hook means to move longitudinally towards the first hook means, and wherein sufficient fastening causes said other of the leading and trailing edges to be received in the transversely spaced apart slots associated with the second hook means.

In an embodiment, the means of fastening the clamping bracket to the mounting bracket is in the form of a vertical fastening plate associated with the upper web element of the mounting bracket and which extends transversely between the two wall flange portions, the fastening plate including an internally threaded aperture for engaging with a bolt associated with the clamping bracket, wherein tightening of the bolt causes said fastening of the clamping bracket to the mounting bracket and movement of the second hook means towards the first hook means.

In an alternate embodiment, the means of fastening the clamping bracket to the mounting bracket is in the form of a vertical fastening plate associated with the upper web element of the mounting bracket and which extends transversely between the two wall flange portions, the fastening plate including a non-threaded aperture for receiving a bolt associated with the clamping bracket, wherein the bolt includes an associated nut that is internally threaded and configured to engage with the bolt on the other side of the fastening plate such that tightening of the bolt causes said fastening of the clamping bracket to the mounting bracket and movement of the second hook means towards the first hook means.

In an embodiment, after each of the leading and trailing edges are received in the corresponding slots associated with first and second hook means, but prior to a full tightening of the bolt to fix the clamping bracket to the mounting bracket, the head is slideable along the support beam and thereby capable of being moved to and fixed at any desired location along the transverse support beam.

In an embodiment, the two spaced apart and substantially vertical wall flange portions of the mounting bracket, or components associated therewith, are configured to support the agricultural tool in said fore or central position when the mounting bracket is mounted in a forwardly disposed configuration, or in said central or aft position when the mounting bracket is mounted in a rearwardly disposed configuration, and include means for fastening the agricultural tool at each of said positions.

In an embodiment, the mounting bracket includes multiple fastening locations along or parallel to said longitudinal axis that enables the agricultural tool to be fastened at any one of the multiple locations.

In an embodiment, the agricultural tool slideably engages the mounting bracket to enable the agricultural tool to be moved along the first axis to a desired location by sliding the agricultural tool to the desired location before being fixed at the desired location.

In an embodiment, the agricultural tool is a tine including a tine shank and associated components including a tine pivot pin about which the tine shank pivots and a spring or hydraulic cylinder for controlling an amount of breakout force on the tine shank, wherein the two vertical wall flange portions accommodate and include means for fastening the spring or hydraulic cylinder and the tine pivot pin therebetween.

In an alternate embodiment, the mounting bracket assembly includes:

a first mounting bracket that engages with one of the leading and trailing edges of the support beam, a second mounting bracket connected to the first mounting bracket wherein the second mounting bracket enables attachment of the agricultural tool, and a clamping bracket that engages with the other of the leading and trailing edges of the support beam to thereby clamp, with the first mounting bracket, the leading and trailing edges of the support beam.

In an embodiment, the first mounting bracket includes an inverted U-shape along its cross section formed by two spaced apart and substantially vertical wall flange portions and an upper web portion.

In an embodiment, the upper web portion includes a first hook means for engaging with said one of the leading and trailing edges of the support beam, and the clamping bracket includes a second hook means for engaging with said other of the leading and trailing edges of the support beam.

In an embodiment, the first hook means includes two transversely spaced apart slots configured to receive said one of the leading and trailing edges of the support beam.

In an embodiment, the second hook means associated with the clamping bracket includes two transversely spaced apart slots that are longitudinally separated from the spaced apart slots associated with the first hook means and configured to receive said other of the leading and trailing edges of the support beam.

In an embodiment, the first mounting bracket is configured such that when the first hook means is engaged with one of the leading or trailing edges of the support beam, the first mounting bracket is caused to suspend from and is thereby supported by the support beam to facilitate use of the clamping bracket to engage with the other of the leading and trailing edges of the support beam.

In an embodiment, the upper web element further includes a means of fastening the clamping bracket to the first mounting bracket, the fastening means configured such that fastening of the clamping bracket causes the clamping bracket and hence the second hook means to move longitudinally towards the first hook means, and wherein sufficient fastening causes said other of the leading and trailing edges to be received in the transversely spaced apart slots associated with the second hook means.

In an embodiment, the means of fastening the clamping bracket to the first mounting bracket is in the form of a vertical fastening plate associated with the upper web element of the first mounting bracket and which extends transversely between the two wall flange portions, wherein either or both of the fastening plate and the clamping bracket includes an internally threaded aperture for engaging with a bolt, wherein tightening of the bolt causes said fastening of the clamping bracket to the first mounting bracket and movement of the second hook means towards the first hook means.

In an alternate embodiment, the means of fastening the clamping bracket to the first mounting bracket is in the form of a vertical fastening plate associated with the upper web element of the first mounting bracket and which extends transversely between the two wall flange portions, each of the fastening plate and clamping bracket including a non-threaded aperture for receiving a bolt, wherein the bolt includes an associated nut that is internally threaded and configured to engage with an external thread of the bolt on an internal side of fastening plate or an outer side of the clamping bracket such that tightening of the bolt causes said fastening of the clamping bracket to the first mounting bracket and movement of the second hook means towards the first hook means.

In an embodiment, after each of the leading and trailing edges are received in the corresponding slots associated with first and second hook means, but prior to a full tightening of the bolt to fix the clamping bracket to the first mounting bracket, the head is slideable along the support beam and thereby capable of being moved to and fixed at any desired transverse location along the transverse support beam.

In an embodiment, the second mounting bracket includes first and second transversely spaced apart plates attached to, and nestled inside, each respective wall flange portion associated with the first mounting bracket.

In an embodiment, the two spaced apart plates of the second mounting bracket, or components associated therewith, are configured to support the agricultural tool in said fore or central position when the mounting bracket is mounted in a forwardly disposed configuration, or in said central or aft position when the mounting bracket is mounted in a rearwardly disposed configuration, and include means for fastening the agricultural tool at each of said positions.

In an embodiment, the second mounting bracket includes multiple fastening locations along or parallel to said longitudinal axis that enables the agricultural tool to be fastened at any one of the multiple locations.

In an embodiment, the agricultural tool slideably engages the second mounting bracket to enable the agricultural tool to be moved along the first axis to a desired location by sliding the agricultural tool to the desired location before being fixed at the desired location.

In an embodiment, the agricultural tool includes, but is not limited to, a tool suitable for one or more of:

cultivating soil, seeding, and fertilizing.

In an embodiment, the agricultural tool is a tine including a tine shank and associated components including a tine pivot pin about which the tine shank pivots and a spring or hydraulic cylinder for controlling an amount of breakout force on the tine shank, wherein the first and second plates associated with the second mounting bracket accommodate and include means for fastening the spring or hydraulic cylinder and the tine pivot pin therebetween.

In a second aspect, the present invention provides a support beam including one or more mounted heads configured in accordance with the first aspect.

In an embodiment, the support beam includes a first and a second edge substantially along its length.

In an embodiment, the support beam extends along a second axis that is substantially transverse to the first axis wherein the first edge is a leading edge of the support beam and the second edge is a trailing edge of the support beam. In an alternative embodiment, the first edge is an upper edge of the support beam and the second edge is a lower edge of the support beam.

In an embodiment, the support beam includes a substantially horizontal clamping plate that extends the length of the support beam and defines said leading and trailing edge of the support beam.

In an embodiment, the support beam further includes side walls that stand substantially upright from the clamping plate.

In an embodiment, the clamping plate and/or the upright side walls house additional components including, but not limited to, one or more of:

hydraulic hoses,

seed delivery hoses,

liquid and granular fertiliser delivery hoses,

electrical or isobus cables,

sensors,

wheels,

drawbar attachment,

connecting beams for connecting the support beam to an additional support beam, and

hydraulic cylinders, including hydraulic cylinders for facilitating folding of a winged portion of the support beam.

In an embodiment, the clamping plate and/or side walls may include additional fastening means for attaching the additional components.

In an embodiment, the support beam includes a plurality of forwardly and/or rearwardly mounted heads such that the agricultural tools, when attached to the heads, are aligned along at least two rows including:

a first row associated with the fore position and a second row associated with the central position; or

a first row associated with the fore position and a second row associated with the aft position; or

a first row associated with the central position and a second row associated with the aft position.

In an embodiment, the support beam includes a plurality of forwardly and/or rearwardly mounted heads such that the agricultural tools, when attached to the heads, are aligned along three rows including a first row associated with the fore position, a second row associated with the central position, and a third row associated with the aft position.

In a third aspect, the present invention provides a self-propelled agricultural machine or frame thereof including one or more support beams configured in accordance with the second aspect.

In an embodiment, the self-propelled agricultural machine or frame thereof includes one of said support beams and a plurality of heads associated therewith such that the agricultural tools, when attached to the heads, are arranged in a single row, two rows or three rows.

In an embodiment, the self-propelled agricultural machine or frame thereof includes two or more of said support beams located at spaced apart intervals along said longitudinal axis and a plurality of heads associated with each support beam such that the agricultural tools, when attached to the heads, are arranged in a single row, two rows or three rows.

### BRIEF DESCRIPTION OF THE DRAWINGS

Features of the present disclosure are illustrated by way of example and not limited in the following figure(s), in which like numerals indicate like elements, in which:

FIG. 1 illustrates a front, top perspective view of a head including a mounting bracket assembly configured to enable attachment of an agricultural tool to a support beam in a fore or aft position according to an embodiment, the head shown attaching a hydraulic tine to a support beam in a fore position.

FIG. 2 illustrates a front, top perspective view of the head of FIG. 1 wherein the suspended agricultural tool is a spring tine.

FIG. 3 illustrates a front, top perspective view of the head of FIG. 1, the head shown attaching a hydraulic tine to a support beam in an aft position.

FIG. 4 illustrates a front, top perspective view of a support beam according to an embodiment, the support beam including a first head arranged according to FIG. 1 attaching a hydraulic tine to the support beam in a fore position and a second head arranged according to FIG. 3 attaching a hydraulic tine to the support beam in an aft position.

FIG. 5 illustrates a front, top perspective view of a towed frame including two longitudinally spaced apart support beams according to an embodiment, wherein each support beam supports two transverse rows of heads and associated hydraulic tines to form a 4-row tine layout.

FIG. 6 illustrates a front, top perspective view of a head including a mounting bracket assembly configured to enable attachment of an agricultural tool to a support beam in a fore or aft position according to another embodiment, the head shown supporting a hydraulic tine.

FIG. 7 illustrates a front, underside perspective view of the head and hydraulic tine of FIG. 6.

FIG. 8 illustrates an exploded view of the head and hydraulic tine of FIG. 6.

FIG. 9 illustrates a further exploded view of the head and hydraulic tine of FIG. 6.

FIG. 10 illustrates a front, top perspective view of a towed frame including two longitudinally spaced apart support beams, the front beam including a first head according to FIG. 6 attaching a hydraulic tine to the front support beam in a fore position and a second head according to FIG. 6 attaching a hydraulic tine to the front support beam in an aft position.

FIG. 11 illustrates a rear, top perspective view of a towed frame of a self-propelled agricultural machine including a support beam according to an embodiment, wherein the support beam supports a single row of heads each including a forwardly disposed mounting bracket assembly supporting a disc and press wheel.

FIG. 12 illustrates a front, top perspective view of a head including a mounting bracket assembly configured to enable attachment of an agricultural tool to a support beam in a central position according to another embodiment, the head supporting a hydraulic tine.

FIG. 13 illustrates an exploded view of the head and hydraulic tine of FIG. 12.

FIG. 14 illustrates a rear, top perspective view of a towed frame of a self-propelled agricultural machine including a support beam, wherein the support beam supports a single row of heads each including a central mounting bracket assembly supporting a disc and press wheel.

FIG. 15 illustrates a front, top perspective view of a towed frame including a support beam, wherein the support beam supports a 2-row tine layout.

FIG. 16 illustrates a top view of the towed frame and support beam of FIG. 15.

FIG. 17 illustrates a front, top perspective view of a towed frame including a first and second support beam, wherein the first and second support beam support a 3-row tine layout.

FIG. 18 illustrates a top view of the towed frame and support beams of FIG. 17.

FIG. 19 illustrates a front, top perspective view of a towed frame including a first and second support beam, wherein the first and second support beam support a 4-row tine layout.

FIG. 20 illustrates a top view of the towed frame and support beams of FIG. 19.

FIG. 21 illustrates a front, top perspective view of a towed frame including a first and second support beam, wherein the first and second support beam support a 5-row tine layout.

FIG. 22 illustrates a top view of the towed frame and support beams of FIG. 21.

FIG. 23 illustrates a front, top perspective view of a towed frame including a first and second support beam, wherein the first and second support beam support a 6-row tine layout.

FIG. 24 illustrates a top view of the towed frame and support beams of FIG. 21.

FIG. 25 illustrates a front, top perspective view of a support beam including a square cross section beam according to a further embodiment.

FIG. 26 illustrates a front, top perspective view of a support beam in the form a truss style beam including two circular cross section beams according to a still further embodiment.

FIG. 27 illustrates a front, top perspective view of a head according to a still further embodiment wherein the head includes a mounting bracket assembly including a cross member extending between vertical wall flange portions thereof to enable attachment of an agricultural tool.

### DETAILED DESCRIPTION OF THE EMBODIMENT(S) OF THE INVENTION

For simplicity and illustrative purposes, the present disclosure is described by referring mainly to one or more examples thereof. In the following description, numerous specific details are set forth in order to provide a thorough understanding of the present disclosure. It will be readily apparent however, that the present disclosure may be practiced without limitation to these specific details. In other instances, some apparatus and methods have not been described in detail so as not to unnecessarily obscure the present disclosure. As used herein, the terms “a” and “an” are intended to denote at least one of a particular element, the term “includes” means includes but not limited to, the term “including” means including but not limited to, and the term “based on” means based at least in part on.

The present invention relates to improvements in agricultural machinery and in particular to an improved head (10a, 10b) for supporting a plurality of different agricultural tools (12), wherein the head (10a, 10b) and the tools (12) may be mounted in a number of different positions relative to a towed support beam (14) to adapt to a wide range of farming practices. For example, the head (10a,10b) is configured to enable attachment of an agricultural tool (12) to a transverse support beam (14) that is towed longitudinally along a first axis (16) by, for example, a self-propelled agricultural machine such as a cultivator (not shown). As will become apparent, the beam (14) may form part of a larger support frame (described in more detail below) configured to be towed by the self-propelled agricultural machine and which may include multiple support beams. The tool (12) may be any agricultural tool suitable to perform functions such as opening soil, applying seed, applying fertilizer and/or closing the soil.

The support beam (14), which extends transversely relative to the longitudinal axis (16), includes a first (18) and second (20) edge substantially along its length. The head (10a, 10b) includes a mounting bracket assembly (22a, 22b, 22c) configured to clamp onto the first (18) and/or second (20) edge of the support beam (14) to thereby fix the mounting bracket assembly (22a, 22b, 22c) at a desired transverse location along the length of the support beam (14). The mounting bracket assembly (22a, 22b, 22c) enables attachment of the agricultural tool (12) such that the agricultural tool (12), when attached, suspends from the clamped mounting bracket assembly (22a, 22b, 22c) and hence from the support beam (14).

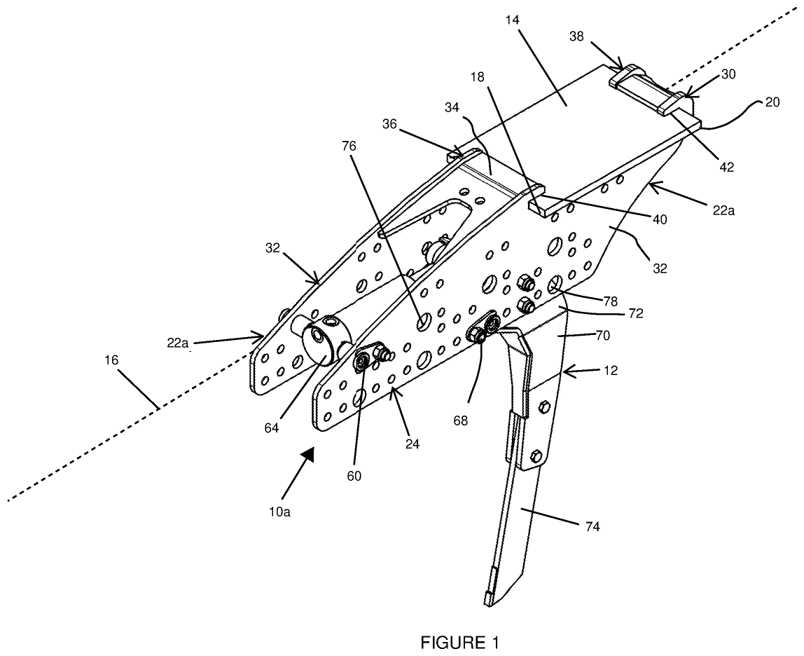

In an alternate embodiment which is not illustrated in the Figures, the support beam could extend along or parallel to the longitudinal axis extending in the direction of travel (i.e. the first axis (16)) such that the first and second edges of the support beam are also aligned along the first axis (16). In this embodiment, the head would need to be configured to ensure that the agricultural tool is correctly suspended relative to the direction of travel so that it may function correctly in the direction of travel (e.g. open soil, apply seed, apply fertilizer, or close soil). However, in the embodiment shown in FIG. 1, the support beam (14) extends along an axis that is substantially transverse to the longitudinal axis (i.e. the first axis (16)). In this embodiment, the first edge (18) is therefore a leading edge of the support beam (14) and the second edge (20) is a trailing edge of the support beam (14).

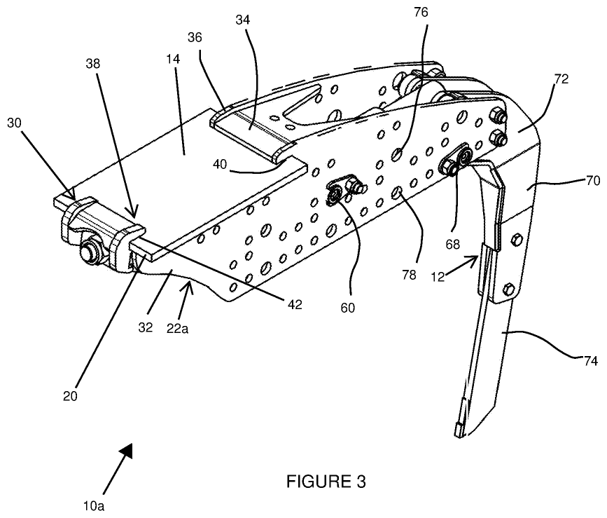

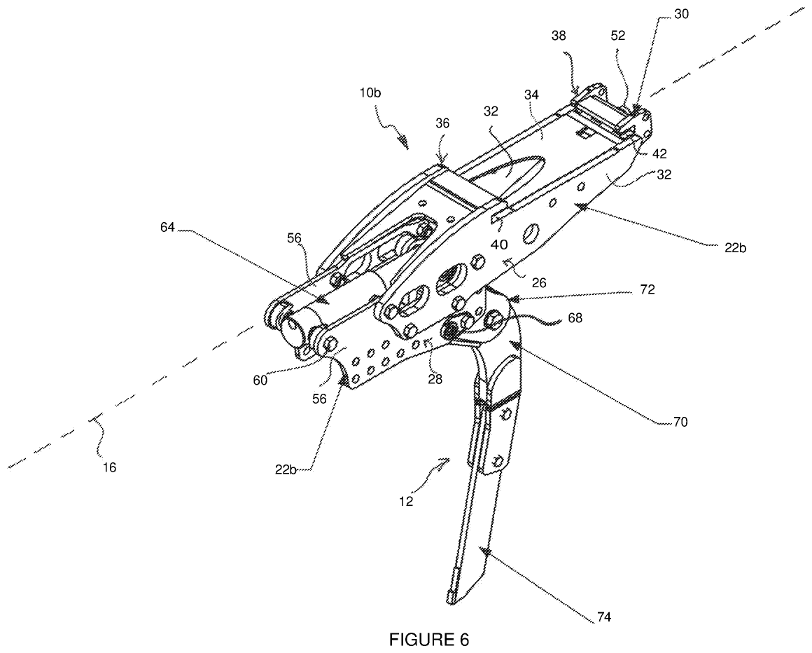

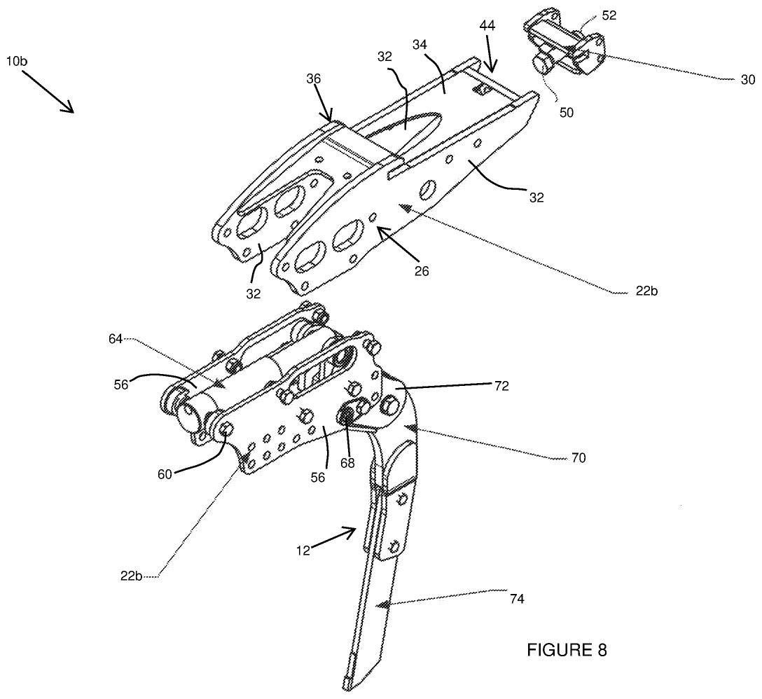

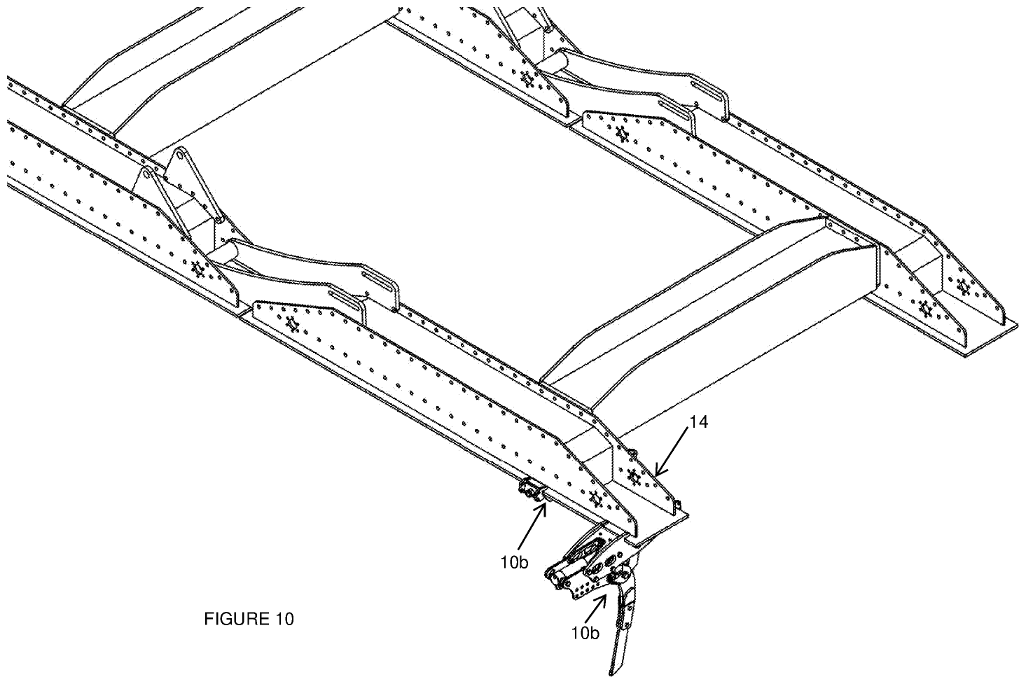

There are two main embodiments described herein with respect to the head of the present invention, namely, head (10a) as depicted in FIGS. 1 to 5 which includes a mounting bracket assembly (22a), and head (10b) as depicted in FIGS. 6 to 14 which includes an alternately configured mounting bracket assembly (22b, 22c). In the case of head (10a), the mounting bracket assembly (22a) is a substantially one-piece construction in that it provides a single bracket (24) between the agricultural tool (12) and the support beam (14). In the case of head (10b), the mounting bracket assembly (22b, 22c) is a substantially two-piece construction in that it provides a first (26) and a nestled second (28) bracket between the agricultural tool (12) and the support beam (14). Whilst either could be configured to allow for attachment of agricultural tools at different longitudinal positions along the length of the mounting bracket assembly, for brevity, only mounting bracket assembly (22a) is shown as being configured in this manner, i.e., with various apertures (76) as described in greater detail below.

It will be appreciated that each support beam (14) is capable of supporting a plurality of heads (10a, 10b) along its length, and the heads may be positioned at any position transversely along the length of the beam to suit a particular farming requirement. In addition, the heads (10a, 10b) may be selected and/or arranged to enable more than one row of agricultural tool (12) to be associated with each support beam (14). Prior to the present invention, if a farmer was seeking to implement a 6-row (also referred to as a 6-rank) tine layout, i.e. 6 longitudinally spaced apart rows of tines, not only would a purpose-built cultivator need to be purchased, but the frames, support beams, tine heads and other components associated with such conventional equipment would only be capable of supporting a single row of agricultural tools for each support beam. Hence, to achieve a 6-row pattern, a conventional towed frame would require six individual support beams.

By using the heads (10a, 10b) of the present invention, and as described in greater detail below, a 6-row tine layout is achievable using only two support beams (14). Indeed, depending on the extent to which the agricultural tools (12) are configured to be moveable (and lockable) in the longitudinal direction relative to each associated mounting bracket assembly (22a, 22b, 22c), a single support beam (14) is likely to be capable of supporting more than three rows of agricultural tools (12).

In one implementation, the head (10a, 10b) is capable of being configured, arranged and/or attached to the support beam (14) in a manner that enables an agricultural tool (12) to be suspended in a fore, central or aft position (i.e. along three different rows) relative to the support beam (14). For example, when head (10a) is attached to the support beam (14) in a configuration where the mounting bracket assembly (22a) and in particular a tool attachment portion thereof is forwardly disposed, this will typically enable an agricultural tool (12) such as a tine to be suspended in a fore or central position relative to the support beam.

When head (10a) is attached to the support beam (14) such that the mounting bracket assembly (22a) and in particular a tool attachment portion thereof is rearwardly disposed (i.e. by rotating the head 180 degrees), this will typically enable an agricultural tool (12) such as a tine to be suspended in the central or an aft position relative to the support beam. In other words, by attaching multiple heads to the support beam, where some are mounted in a manner that their tool attachment portions extend forwardly and others are mounted such that their tool attachment portions extend rearwardly, three or more longitudinally spaced apart rows of tools may be established in respect of a single support beam.

It is possible to use a forwardly or rearwardly disposed head (10a) to enable an agricultural tool (12) to be suspended in the central position relative to the support beam, i.e. substantially beneath the support beam (14), by using either the forwardly disposed mounting bracket assembly (22a) and selecting a rear mounting location for attachment of the agricultural tool (12), or by attaching the head (10a) such that the mounting bracket assembly is rearwardly disposed and selecting a front mounting location for attachment of the agricultural tool (12). This will allow a machine to be set up with up to three (and potentially more) rows of tines for each support beam.

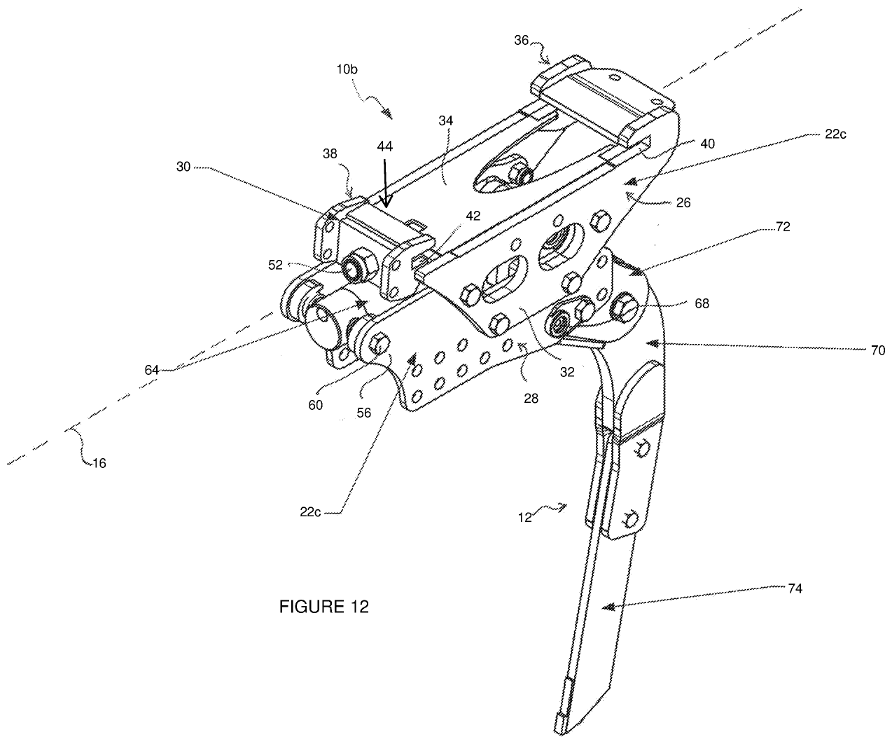

However, it is to be understood that other additional configurations are possible. For example, whilst head (10b) is also configured to be attached to the support beam (14) such that mounting bracket assembly (22b) is either forwardly or rearwardly disposed (to enable an agricultural tool (12) such as a tine to be suspended in the fore or aft positions respectively), head (10b) may include a purpose-built mounting bracket assembly (22c) that is centrally disposed to enable an agricultural tool (12) such as a tine to be suspended in the central position relative to the support beam. Head (10b) incorporating a mounting bracket assembly (22c) configured in this manner is shown in FIGS. 12 to 14.

The mounting bracket assembly (22a, 22b, 22c) may be configured to clamp either one of the leading (18) or trailing (20) edge of the support beam (14), or in another configuration, both the leading (18) and trailing (20) edges of the support beam (14). Since clamping to only one of the leading or trailing edges represents an attachment of potentially reduced strength as compared with clamping both the leading and trailing edge, it is envisaged that this configuration would be used to attach minor agricultural tools including, for example, hydraulic hose mounts, liquid fertiliser manifolds, airseeder hoses and riser kits (not shown). Clamping to a single edge may be achieved by a sandwich-type clamping configuration, e.g. involving a bracket (not shown) clamping to the top and bottom of the leading (18) or trailing (20) edge and the use of appropriately shaped bolt(s) (not shown).

According to embodiments depicted in the present Figures, the mounting bracket assembly (22a, 22b, 22c) is configured to clamp both the leading (18) and trailing (20) edges of the support beam (14).

For example, the mounting bracket assembly (22a) associated with head (10a) includes mounting bracket (24) configured to enable attachment of the agricultural tool (12) and to engage with one of the leading or trailing edges of the support beam, whilst a clamping bracket (30) is used to engage with the remaining edge to thereby clamp, together with the mounting bracket (24), the leading (18) and trailing (20) edges of the support beam (14).

The mounting bracket assembly (22b, 22c) associated with head (10b) includes a first mounting bracket (26) that engages with one of the leading (18) and trailing (20) edges of the support beam (14), i.e. similar to bracket (24), and a second mounting bracket (28) connected to the first mounting bracket (26) wherein the second mounting bracket (28) enables attachment of the agricultural tool (12). A clamping bracket (30) is again used to engage with the opposed edge to thereby clamp, together with the first mounting bracket (26), the leading (18) and trailing (20) edges of the support beam (14).

Each of the mounting brackets (24, 26) of mounting bracket assemblies (22a, 22b, 22c) may have an inverted U-shape along its cross section formed by two spaced apart and substantially vertical wall flange portions (32) and an upper web portion (34). The upper web portion (34) may include, at a first longitudinal end, a first hook means (36) for engaging with one of the leading (18) or trailing (20) edges of the support beam (depending on whether the bracket assembly is to be forwardly or rearwardly disposed, i.e. leading edge (18) if forwardly disposed, and trailing edge (20) if rearwardly disposed). At its opposite longitudinal end, the upper web portion (34) includes a second hook means (38) for engaging with the opposite edge of the support beam.

The mounting brackets (24, 26) associated with respective mounting bracket assemblies (22a, 22b) are of an elongate shape such that the upper web portion (34) and associated first hook means (36) are located at or adjacent one end of the bracket and the two vertical wall flange portions (32) extend downwardly from the upper web portion (34) before projecting longitudinally beyond the dimension of the upper web portion (34). In mounting bracket (24) associated with mounting bracket assembly (22c), the side wall flange portions (32) extend downwardly but do not project longitudinally beyond the dimension of the associated upper web portion (34) since mounting bracket assembly (22c) is configures for mounting tools only centrally relative to the support beam.

The first hook means (36), which is associated with bracket (24, 26), may include two transversely spaced apart slots (40) configured to receive one of the leading (18) or trailing (20) edges of the support beam (14), depending on its forward or rearward orientation. The second hook means (38), which is associated with clamping bracket (30), includes two transversely spaced apart slots (42) that are opposed to the spaced apart slots (40) when the bracket (30) is attached. The slots (42) are configured to receive the opposite edge of the support beam (14). In an embodiment, the mounting bracket (24, 26) may be configured such that when the first hook means (36) is engaged with one of the leading (18) or trailing (20) edges of the support beam (14), the mounting bracket (24, 26) suspends from and is thereby supported by the support beam (14). Since the head (10a, 10b) can be supported on its own after it has been lifted up and affixed to the support beam using first hook means (36), the skilled addressee will appreciate that finalising the clamping process by affixing the clamping bracket (30) is a task that can then easily be completed manually by a user. In particular, the user (who no longer has to support the weight of the head (10a, 10b) since it is being supported by the support beam (14)), can easily then attach the clamping bracket (30) to the opposite edge of the support beam (34).

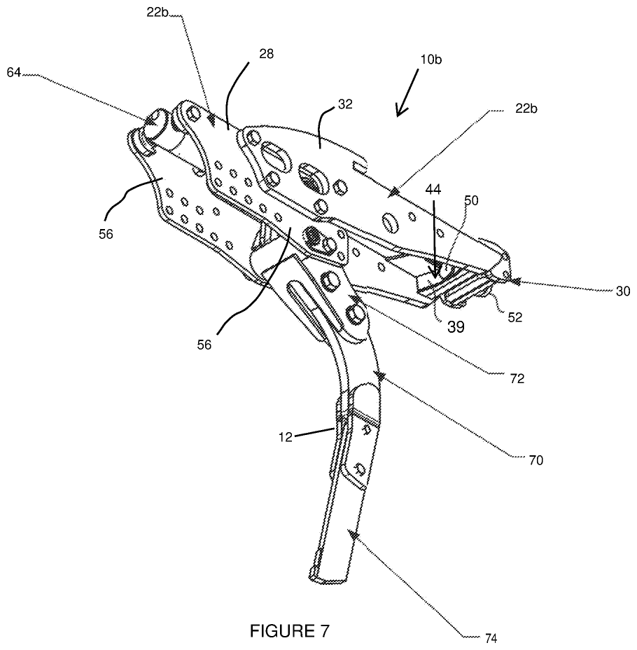

The clamping mechanism shown in the presently described and illustrated embodiments involves a fastening means (44) disposed beneath the upper web portion (34) of the mounting bracket (24, 26) and extending between the vertical wall flange portions (32), as shown most clearly in FIG. 7. The fastening means (44) is configured such that using the fastening means (44) to fasten the clamping bracket (30) to the mounting bracket (24, 26), as described in more detail below, causes the clamping bracket (30) and hence the second hook means (38) to move in a longitudinal direction towards the first hook means (36), and wherein sufficient fastening causes the second edge of the support beam (14) to be received in the transversely spaced apart slots (42) associated with the second hook means (38).

In the embodiments shown, the fastening means (44) includes a fastening plate (39) beneath the upper web element (34) of the mounting bracket (24, 26) and extending transversely between the two wall flange portions (32), the fastening plate (39) and the clamping bracket (30) each including a co-axially aligned aperture (not shown) for accommodating a bolt (50) associated with the clamping bracket (30). Tightening of the bolt (50) causes fastening of the clamping bracket (30) to the fastening plate (39) and hence to the mounting bracket (24, 26), and thereby movement of the second hook means (38) towards the first hook means (36). The apertures could be internally threaded to engage with the external thread of the bolt (50), or could be non-threaded which would require the use of a nut (52) to engage the bolt, e.g. on the inner side of the vertical fastening plate (39), or on the outer side of the clamping bracket (30) as shown in FIG. 7.

It is to be understood that the clamping bracket (30) as shown in the Figures represents but one method of clamping to the second edge of the support beam (14), and that other clamping configurations may be implemented such as an overcentre-type clamp (not shown), for quick and easy adjustment, a cam/roller type arrangement (not shown) or a wedge-type arrangement (not shown).

After each of the leading (18) and trailing (20) edges of the support beam (14) are received in the corresponding slots (40, 42) associated with the respective first (36) and second (38) hook means, but prior to a full tightening of the bolt (50) to lock the clamping bracket (30) to the mounting bracket (24, 26), the head (10a, 10b) is transversely slideable along the support beam (14). Accordingly, the head (10a, 10b) is capable of being moved to and fixed at any desired location along the transverse support beam.

Turning now to attachment of the agricultural tool (12), it should be apparent that in mounting bracket assembly (22a), the agricultural tool (12) will be supported by the mounting bracket (24), and in mounting bracket assemblies (22b, 22c), the agricultural tool (12) will be supported by the second nestled mounting bracket (28). The second mounting bracket (28) of mounting bracket assemblies (22b, 22c) includes transversely spaced apart plates (56) that may be attached to each respective wall flange portion (32) of the first mounting bracket (26) such that they extend at least partially along an inside surface thereof. Various fastening means to facilitate attachment of the plates (56) to the wall flange portions (32), including apertures extending through the respective members and configured to be aligned so as to accommodate fastening means such as nuts and bolts, are depicted in the Figures but not described herein since such methods of fastening would be known to the skilled person.

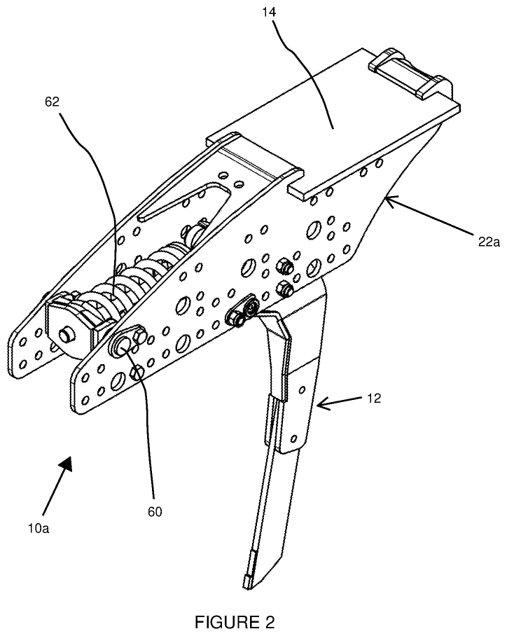

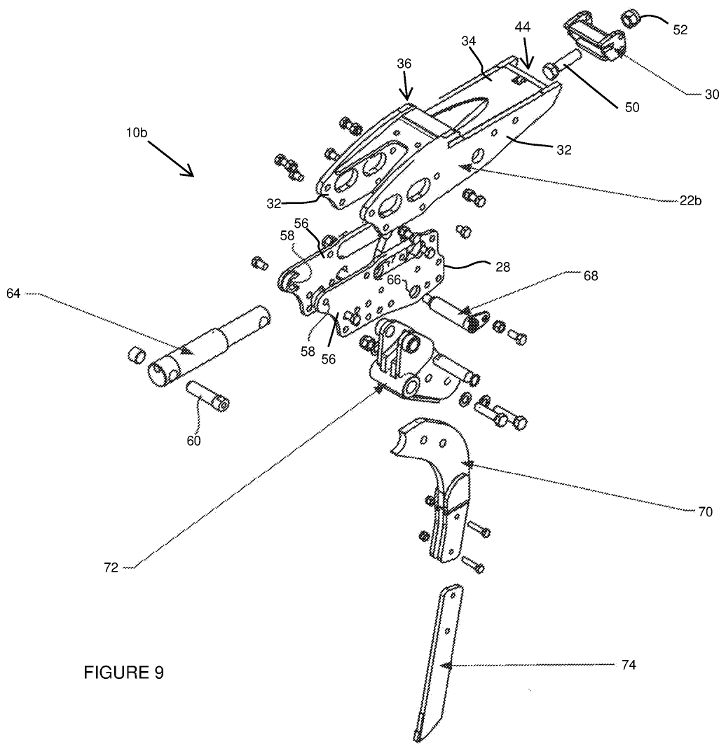

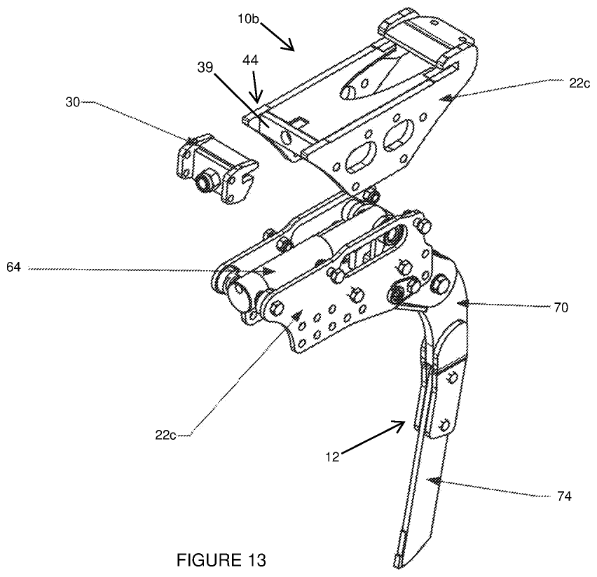

The two spaced apart and substantially vertical wall flange portions (32) of the mounting bracket (24) of mounting bracket assembly (22a), the second mounting bracket (28) of mounting bracket assembly (22b), and the second mounting bracket (28) of mounting bracket assembly (22c), are each configured to support an agricultural tool (12) and further include means for fastening the agricultural tool (12) and any associated components. For example, to accommodate an agricultural tine (12), each includes at least one set of upper coaxial apertures (58) for accommodating a spring or hydraulic cylinder pivot pin (60) that supports and allows for pivot of one end of a spring (62) (shown in FIG. 2 by way of example) or hydraulic cylinder (64) about the pivot pin axis, and at least one set of lower coaxial apertures (66) for accommodating a tine pivot pin (68) about which the tine shank (70) pivots. The tine (12) further includes a tine pivot bracket (72) and opener (74). These features are shown most clearly in the exploded views of FIGS. 9 and 13.

The skilled addressee would appreciate that the spring (62) or hydraulic cylinder (64) are used to control an amount of breakout force on the tine shank (70), i.e. to ensure sufficient pressure to maintain the tine shank position whilst working, whilst allowing the tine to “breakout” if it encounters an obstacle like a rock. The use of a hydraulic cylinder (64) may be preferred over a spring (62) since it allows quick adjustment of breakout pressure. The pressure required can vary depending on hardness of ground, depth of digging, moisture, speed of travel, amongst other factors.

As previously described, mounting bracket assembly (22a) may be configured in a manner that allows the agricultural tool (12) to be mounted at different positions along its length. In this regard, the mounting bracket (24) includes a plurality of spaced apart upper coaxial apertures (76) that are capable of accommodating the hydraulic cylinder pivot pin (60) and a plurality of spaced apart lower coaxial apertures (78) that are capable of accommodating the tine pivot pin (68). For example, in the embodiment shown in FIG. 1, the skilled addressee will appreciate that the tine (12) can be mounted in two possible locations along the length of the assembly (22a) including the location in which it is mounted in FIG. 1 and in a second rearward location. The mounting brackets (28) associated with mounting bracket assemblies (22b, 22c) also include means for accommodating tools at different positions along their longitudinal length.

The mounting brackets (24, 28) may alternatively be configured in a manner that allows the agricultural tool to slideably engage the mounting brackets which would enable the agricultural tool to be easily shifted in the longitudinal direction to a desired location prior to being fixed at that location.

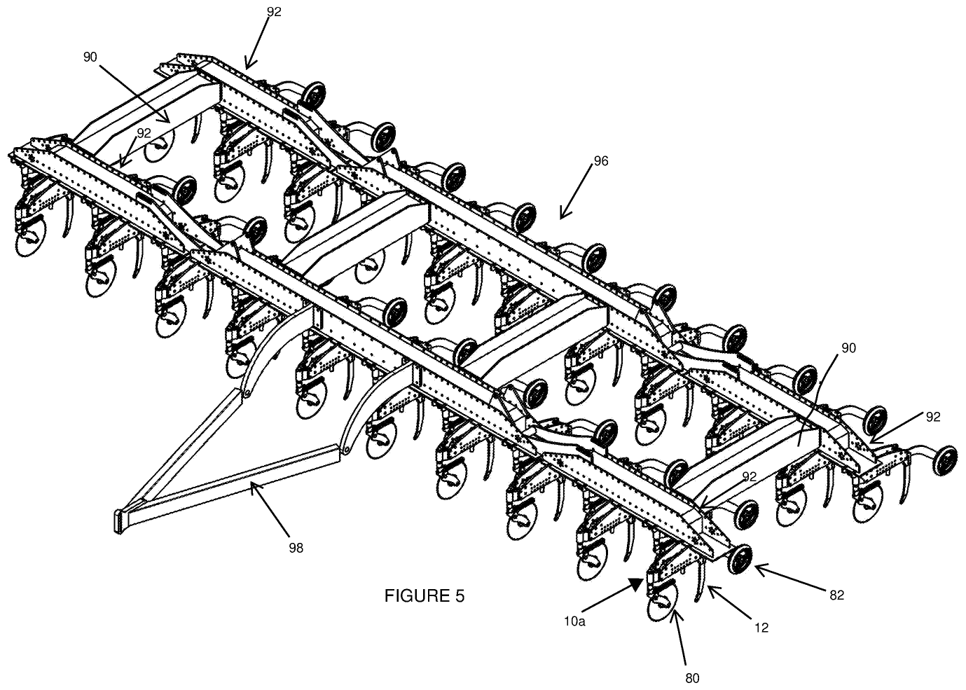

The various additional apertures depicted in mounting bracket (24) and second mounting bracket (28) may also be of a size and position to accommodate additional tools to accompany the main agricultural tool (12). For example, and as shown clearly in FIG. 5, a tine (12) could be accompanied by a disc (coulter) (80) for initially opening the ground and to cut through weeds and a previous crop's stubble/residue. The tine (12) will typically follow for opening the ground and may include a tube (not shown) for dropping seed, and a press wheel (82) may also be used behind the tine for pulling soil back in over the seed. Such tools that require fewer or only a single aperture, for example, for mounting and hence in respect of such tools, there may be more than two possible mounting locations along the length of the assembly (22a, 22b, 22c). In other words, a coulter, tine and press wheel could be accommodated by a single head (10a, 10b). An example is shown in FIG. 5 in which the disc (80) is attached using apertures located at the front of the mounting bracket (24) of head (10a), and the press wheel (82) is attached to the same mounting bracket (24) so that it is independent of the tine (12), or it could also be attached directly to the tine (12).

The main agricultural tool (12) may include a tine and/or additional components as described above, and the agricultural tool(s) will be selected depending on the farming requirement. For example, other agricultural tools may include a deep ripper, subsoiler tines, fertilizer banding tools, a trash cutter or row crop attachments (not shown).

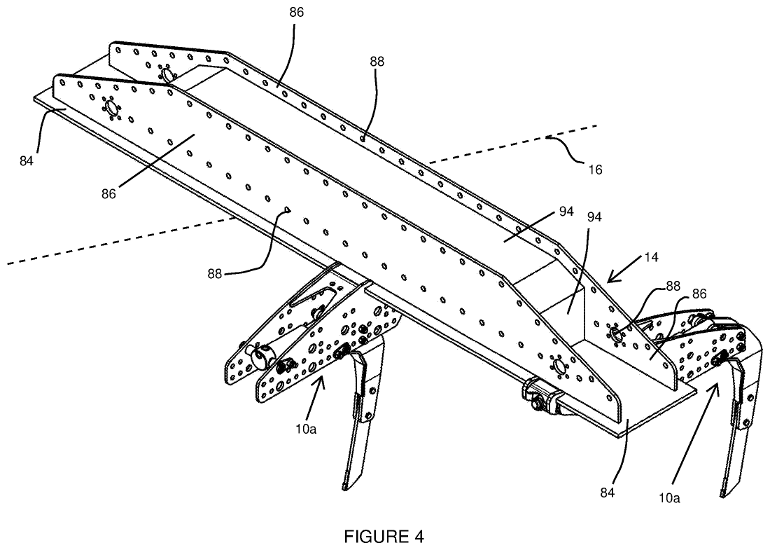

The support beam (14) may also be configured in a number of different ways. In the embodiments described and depicted in the drawings (see FIGS. 4 and 5 for example), the support beam (14) includes a substantially horizontal clamping plate (84) that extends the length of the support beam (14) and defines the leading (18) and trailing (20) edge of the support beam (14). The support beam (14) may further include side walls (86) that stand substantially upright from the clamping plate (84). Each of these components, either separately or in combination, may include additional fastening means (88) for supporting additional components, including but not limited to one or more of hydraulic hoses (not shown), seed delivery hoses (not shown), liquid and granular fertiliser delivery hoses (not shown), electrical or isobus cables (not shown), sensors (not shown), wheels (not shown), drawbar attachments (not shown), connecting beams (90) for connecting the support beam to an additional support beam, and hydraulic cylinders (not shown) including cylinders for facilitating the folding of a winged portion (92) of the support beam as shown in FIG. 5. The support beam (14) may also include additional housing (94) to create, for example, a box beam structure for strength and also for sheltering certain additional components from the elements.

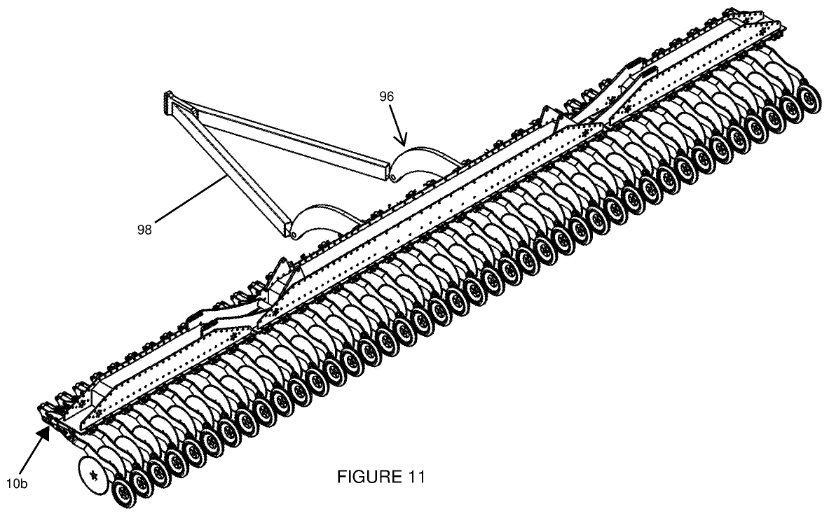

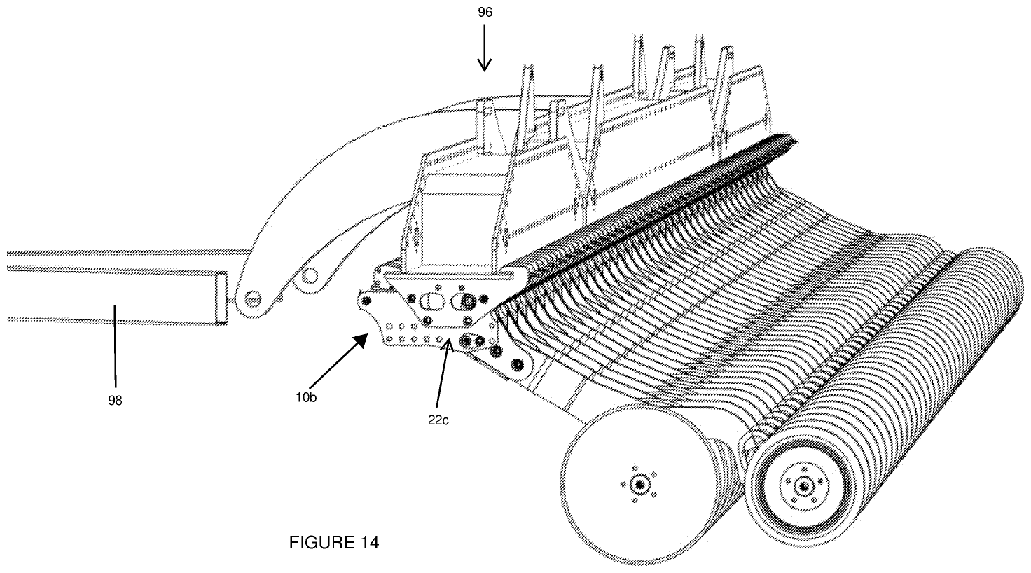

As shown in FIGS. 5, 11 and 14, the support beam (14) may form part of a larger support frame (96) including a drawbar (98) adapted to be towed, e.g. by a self-propelled agricultural machine (not shown). FIG. 5 shows a plurality of heads (10a) in use which each incorporate mounting bracket assembly (22a). FIG. 11 shows a plurality of heads (10b) in use which each incorporate mounting bracket assembly (22b). FIG. 14 shows a plurality of heads (10b) in use which each incorporate mounting bracket assembly (22c). It should therefore be appreciated that any number of combinations of heads (10a, 10b) and/or mounting bracket assemblies (22a, 22b, 22c) may be utilised depending on the user's preference and the particular farming application.

In the case of FIGS. 13-14, it will be appreciated that the head (10b) incorporating mounting bracket assembly (22c), whilst including a first bracket (26) suspended centrally beneath the support beam, still includes a tool mounting portion (i.e. second bracket (28)) that will extend forwardly or rearwardly disposed relative to the support beam (18) depending on the orientation in which the head (10b) is mounted. In other words, even though mounting bracket assembly (22c) is suspended more centrally than mounting bracket assembly (22a) or (22b), it is still capable of mounting agricultural tools in more than one position along its longitudinal length relative to the support beam (18).

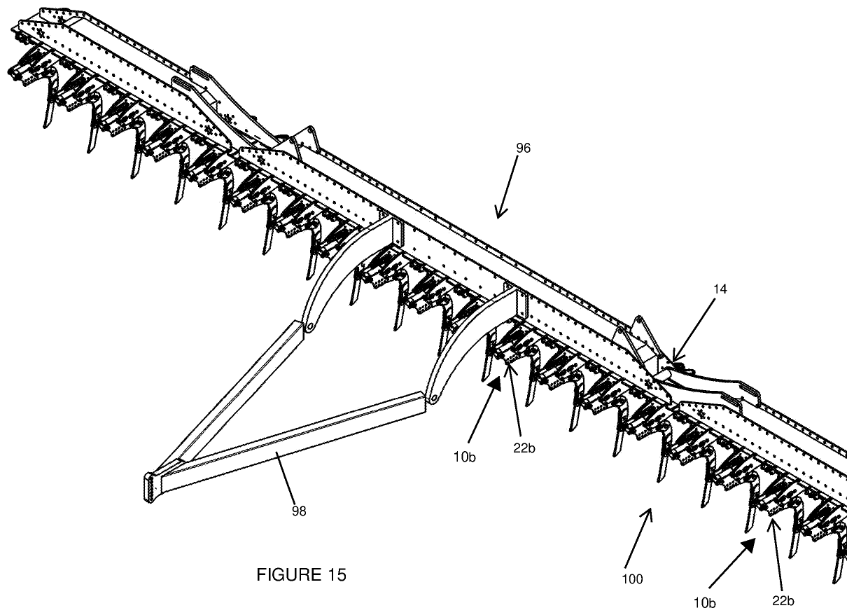

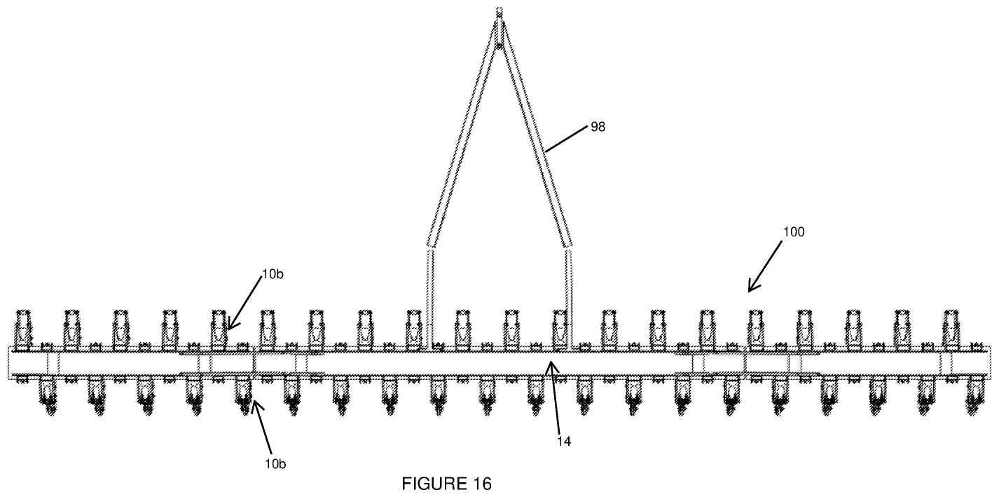

FIGS. 15 to 24 depict different tine layouts that are possible using, for example, different combinations of heads (10b) and mounting bracket assemblies (22b, 22c). For example, FIGS. 15 and 16 depict a towed frame 96 wherein a support beam (14) supports a first plurality of heads (10b) mounted in a forwardly disposed configuration, i.e. where the mounting bracket assembly (22b) and in particular a tool attachment portion thereof extends forwardly relative to the support beam, for supporting a first row of hydraulic tines (12) in a fore position, and a second plurality of heads (10b) mounted in a rearwardly disposed configuration for supporting a second row of hydraulic tines (12) in an aft position, to form a 2-row tine layout (100). In the embodiment shown, the heads (10b) are arranged in an alternating forward-rearward pattern which utilises the same head but wherein each second head is rotated by 180 degrees.

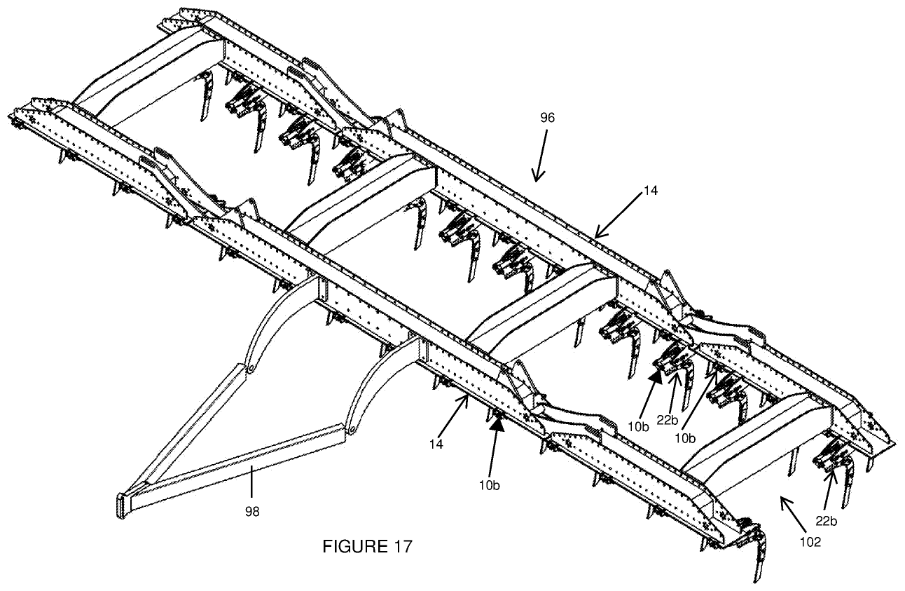

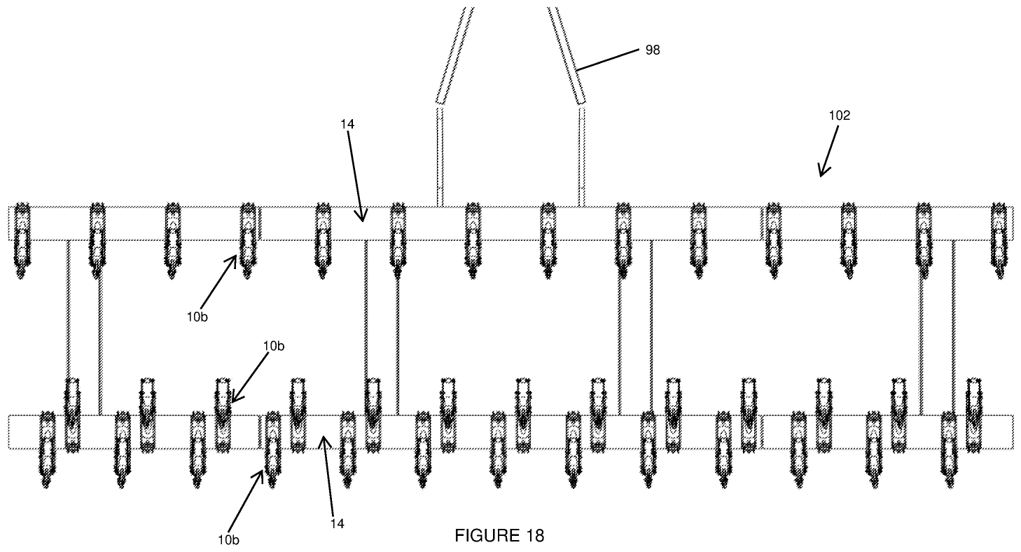

FIGS. 17 and 18 depict a towed frame (96) wherein a first (front) support beam (14) supports a first plurality of heads (10b) each including a rearwardly disposed mounting bracket assembly (22b) for supporting a first row of hydraulic tines (12) in an aft position relative to the first support beam, and a second (rear) support beam (14) supports a second and third plurality of heads (10b). The plurality of heads (10b) associated with the second support beam include alternating forwardly and rearwardly disposed mounting bracket assemblies (22b) for supporting a second row of hydraulic tines (12) in a fore position relative to the second support beam, and a third row of hydraulic tines (12) in an aft position relative to the second support beam, to form a 3-row tine layout (102).

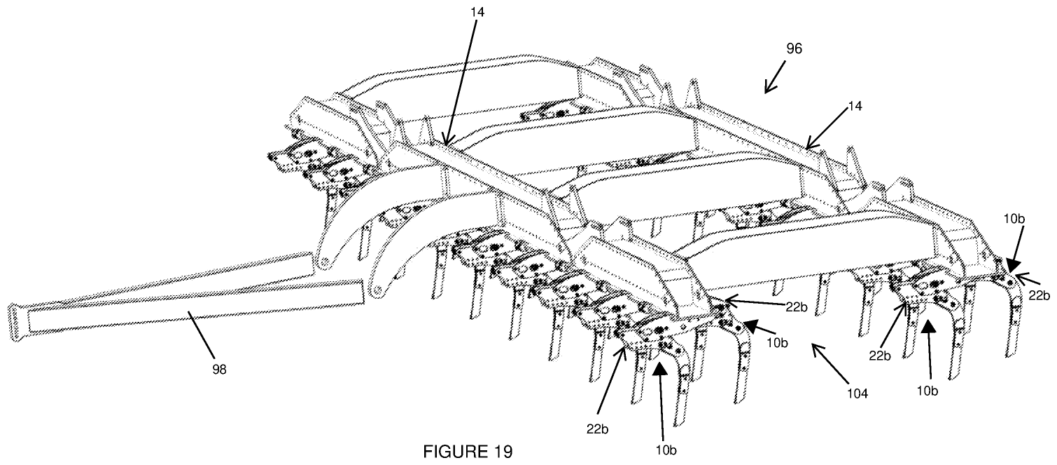

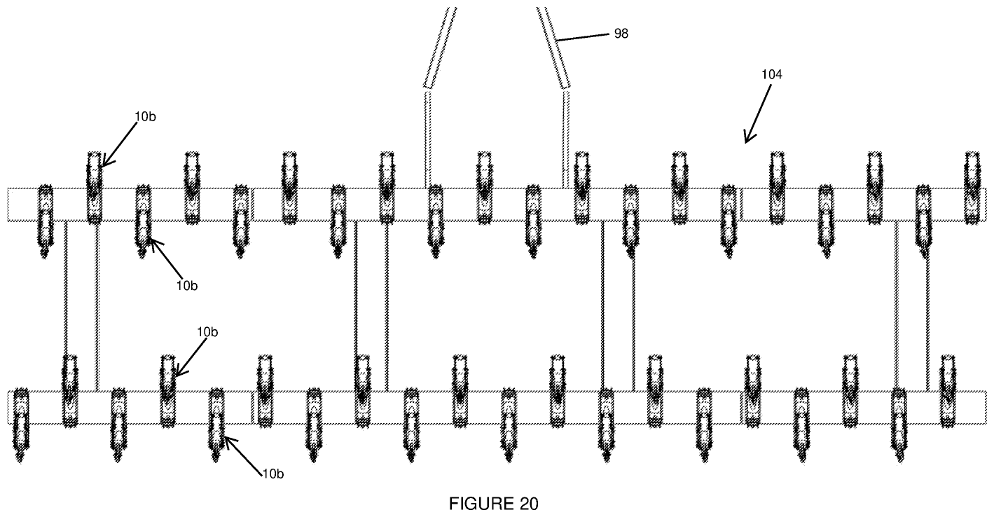

FIGS. 19 and 20 depict a towed frame (96) wherein a first (front) support beam (14) supports a first plurality of heads (10b) each including a forwardly disposed mounting bracket assembly (22b) for supporting a first row of hydraulic tines (12) in a fore position relative to the first support beam, and a second plurality of heads (10b) each including a rearwardly disposed mounting bracket assembly (22b) for supporting a second row of hydraulic tines (12) in an aft position relative to the first support beam. The frame (96) further includes a second (rear) support beam (14) supporting a third plurality of heads (10b) each including a forwardly disposed mounting bracket assembly (22b) for supporting a third row of hydraulic tines (12) in a fore position relative to the second support beam, and a fourth plurality of heads (10b) each including a rearwardly disposed mounting bracket assembly (22b) for supporting a fourth row of hydraulic tines (12) in an aft position relative to the second support beam, to form a 4-row tine layout (104).

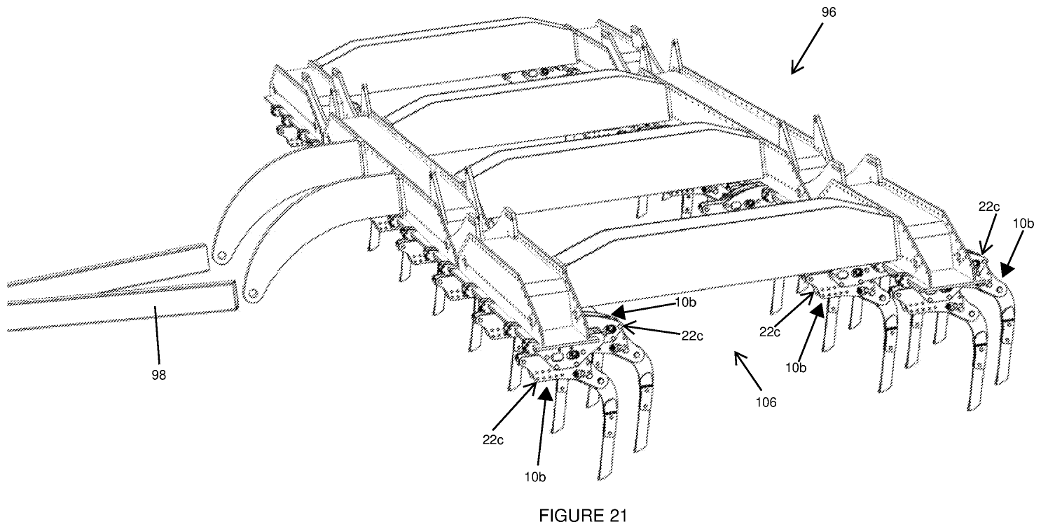

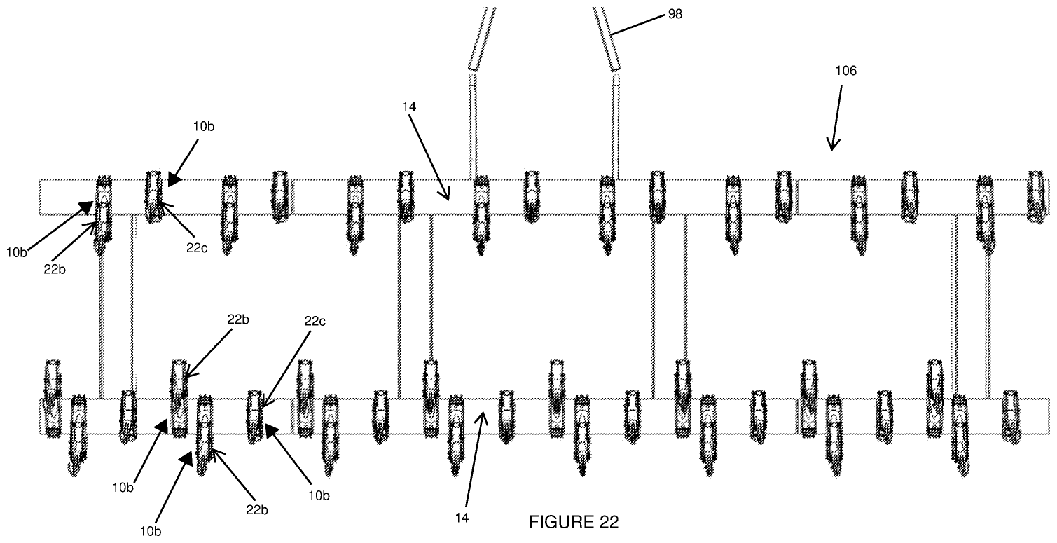

FIGS. 21 and 22 depict a towed frame (98) wherein a first (front) support beam (14) supports a first plurality of heads (10b) each including a central mounting bracket assembly (22c) for supporting a first row of hydraulic tines (12) in a central position relative to the first support beam, and a second plurality of heads (10b) each including a rearwardly disposed mounting bracket assembly (22b) for supporting a second row of hydraulic tines (12) in an aft position relative to the first support beam. A second (rear) support beam (14) is also shown and supports a third plurality of heads (10b), each including a forwardly disposed mounting bracket assembly (22b) for supporting a third row of hydraulic tines (12) in a fore position relative to the second support beam, a fourth plurality of heads (10b) each including a central mounting bracket assembly (22c) for supporting a fourth row of hydraulic tines (12) in a central position relative to the second support beam, and a fifth plurality of heads (10b) each including a rearwardly disposed mounting bracket assembly (22b) for supporting a fifth row of hydraulic tines (12) in an aft position relative to the second support beam, to form a 5-row tine layout (106). The skilled addressee will appreciate that there is a repeating pattern of heads (10b) along the length of each support, i.e. a repeating pattern of two heads in the first support beam, and a repeating pattern of three heads (10b) along the length of the second support beam.

The skilled person will further appreciate that additional rows could be achieved in the tine layout of FIGS. 21 and 22 by, for example, causing the front support beam (14) to support a forwardly disposed mounting bracket assembly (22b) (say every second or third head) to thereby support a sixth row of tines in the fore position of the front support beam.

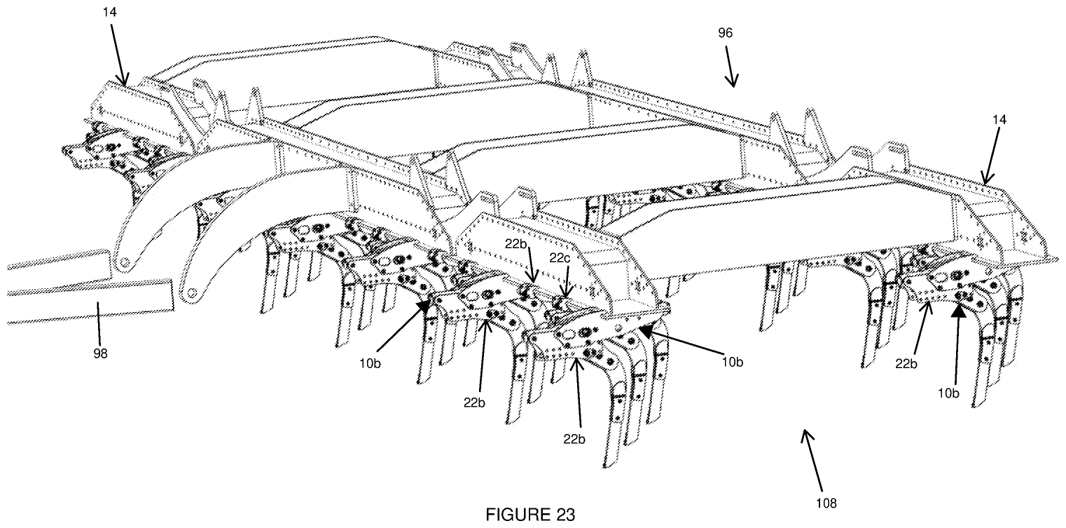

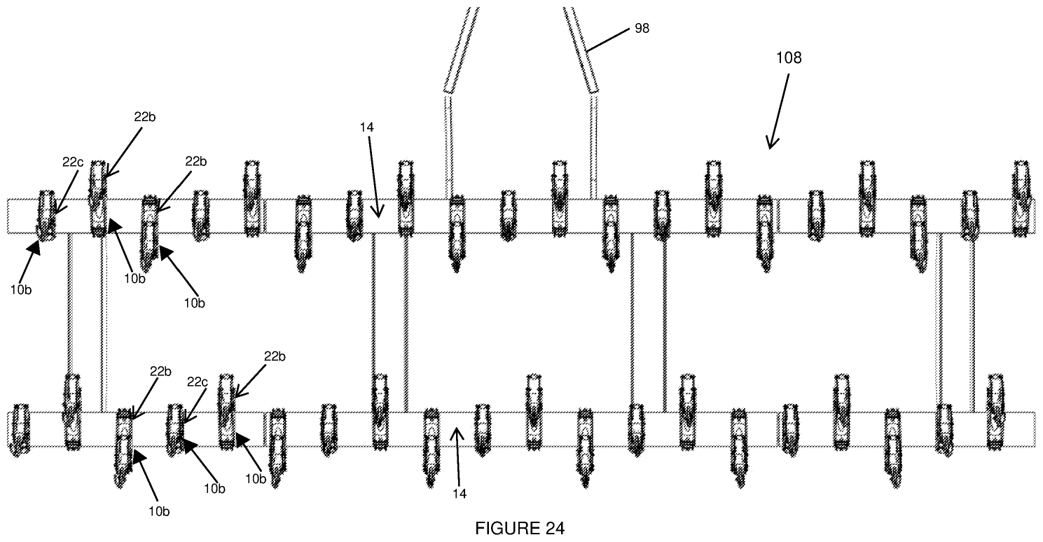

FIGS. 23 and 24 depict a towed frame (98) wherein a first (front) support beam (14) supports a first plurality of heads (10b) each including a forwardly disposed bracket assembly (22b) for supporting a first row of hydraulic tines (12) in a fore position relative to the first support system, a second plurality of heads (10b) each including a central mounting bracket assembly (22c) for supporting a second row of hydraulic tines (12) in a central position relative to the first support beam, and a third plurality of heads (10b) each including a rearwardly disposed mounting bracket assembly (22b) for supporting a third row of hydraulic tines (12) in an aft position relative to the first support beam. A second (rear) support beam (14) supports a fourth plurality of heads (10b) each including a forwardly disposed mounting bracket assembly (22b) for supporting a fourth row of hydraulic tines (12) in a fore position relative to the second support beam, a fifth plurality of heads (10b) each including a central mounting bracket assembly (22c) for supporting a fifth row of hydraulic tines (12) in a central position relative to the second support beam, and a sixth plurality of heads (10b) each including a rearwardly disposed mounting bracket assembly (22b) for supporting a sixth row of hydraulic tines (12) in an aft position relative to the second support beam, to form a 6-row tine layout (108).

A 7^{th} row could potentially be created by incorporating an extension arm (not shown) to clamp onto the main support beam such that the extension arm extends forwardly or rearwardly of the support beam. For example, a beam could be mounted to the support arm and fitted with a tine head (10a, 10b) having a central mounting bracket assembly (22c). This longitudinal extension arm could be used in the fore and aft positions on both support beams, effectively making a 7, 8, 9 and even 10-row tine layout (not shown) possible. It should be appreciated that a significant number of different tool layouts can be achieved using just one or two support beams and the heads (10a, 10b) embodying the present invention.

Some farming techniques may necessitate an increase in the longitudinal distance between tine rows, and this could be achieved using a longer tine head for example, i.e. a tine head (10a,10b) having a mounting bracket assembly (22a, 22b) projecting further forward or further back. This would enable positioning of a tine (12) further forward (i.e. in the fore position relative to the support beam) and further back (i.e. in the aft position relative to the support beam). By increasing create depth between one tine row and the next along a support beam, e.g. increasing the depth between a forward mounted tine and a central mounted tine, or between the central mounted tine and a rear mounted tine, stubble flow through the machine may be improved.

It is to be understood that the Figures which include a towed frame (98) depict only a very basic machine frame for the purpose of facilitating visualisation of the main aspects of the present invention. In this regard, components such as the main wheels, hydraulics, and other components which are necessary for the frame (98) to move and for hydraulic fluid, seeds, fertilizer and the like to be supplied where required, are not shown.

The skilled addressee will now appreciate the various advantages arising from the present invention. As described in detail above, there are increased options available to the farmer using the same number of componentry as a conventional machine. For example, a 2-beam configuration can be set up by an individual to create a 2, 3, 4, 5 or 6 row tine layout pattern using the heads (10a, 10b) described herein. The ability to stagger the tine assemblies also improves trash/stubble handling. This addresses at least the problem of machines acting like a rake, which can compromise the task being performed by the machine (e.g. precision seeding), due to a build-up of stubble between tines which then starts to “bulldoze” the soil. Certain points on a cultivator/seeder can be more prone to stubble blockages than others. By using the tine head, etc., of the present invention, a farmer can configure a tine layout to get the best stubble flow through the machine and thereby eliminate stubble blocking.

The improved head of the present invention gives the end user (farmer) increased control during the purchasing process in that the machine can be set up exactly (or very close to) their desired configuration. For example, setting up the machine may include the steps of (a) determining the overall width of the machine, (b) setting how many rows (or ranks) the farmer requires, (c) setting the tine spacing, (d) setting the type of seeding system required, e.g. tine or disc etc., (e) setting the machine up as either a fixed hitch, or floating hitch machine, and (f) setting the wheel tracks to suit their farming practise, e.g. main wheels on 3 metre centres for Controlled Traffic Farming (CTF). If this particular setting needs to be altered in a subsequent farming task or season, then the farmer can easily purchase the additional components required (e.g. additional or alternately configured heads) to suit the new application, without having to purchase an additional machine.

In other words, a farmer can purchase a machine, knowing that they can alter it in the future to suit their own needs by altering the configuration of the machine in the manner required. This allows a farmer to adapt the machine to changing farming practices as required, without having to purchase new machinery each time. For example, a farmer can start at a base level and upgrade the machine over time, e.g. purchase with only spring tines, then add press wheels when affordable, then add coulters, liquid fertiliser etc. The width of the machine can also be changed to suit requirements. For example, where previously a second machine would need to have been purchased to optimise different seasonal and weather conditions, by utilising the present invention, one machine can be altered to suit needs in a relatively short time frame. The present invention further allows for future innovations i.e. robotics and automation to be incorporated due to its adaptable and modular nature. Resale value is also anticipated to remain high since the machine can be altered to suit individual needs, or re-purposed, hence a farmer can buy a second hand machine and still alter it as required.

The modular design means that a machine can be flat packed and assembled on site. In this regard, the overall system can be considered to comprise an upper component and a lower component, where for example the lower component includes the tine, tine head, discs, press wheels etc., i.e. the “working tools”. This makes the system completely adaptable since the working tools are free to operate without being impeded or limited by the framework of the machine (frame, tyres, drawbar, braces, gussets, brackets etc). The upper component including the support beam, etc, is also adaptable and modular, and is designed so that it is positioned above the clearance point for the tines etc. The upper component is where the peripheral seeding components may be fitted (hydraulics, airseeder hoses, liquid fertiliser equipment, etc.).

A machine configured in accordance with the present invention is also expected to be easier to service due to reduced framework in the lower component. In some known machines, servicing the machine requires crawling through the machine in order to access certain components. The present invention is designed for service accessibility from the front and rear of the machine, as well through the middle of the machine, due to the frame components being positioned above the tine clearance points.

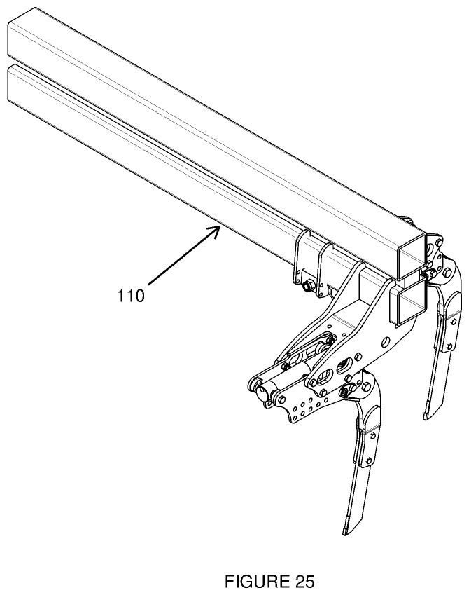

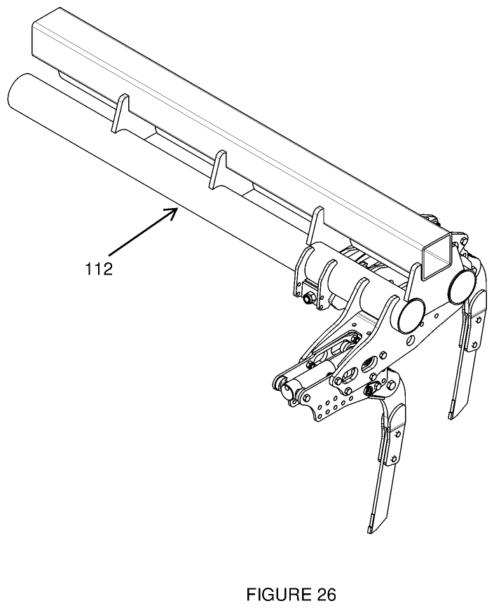

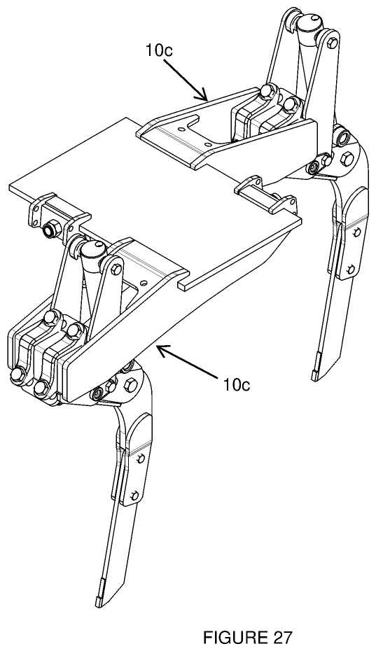

FIGS. 25 and 26 illustrate additional viable variations of the support beam, including support beam (110) in FIG. 25 which includes a square cross section beam to which a head is clamped, and support beam (112) in FIG. 26 which is a truss style beam that enables a head to be clamped to two longitudinally spaced apart circular cross section beams. FIG. 27 also shows a head (114) according to a further embodiment including a mounting bracket having a cross member (not shown) extending between the wall flange portions to support the agricultural tool, which is different to the previous embodiments in which the tool was fastened directly to the wall flange portions. These Figures demonstrate how various alternative embodiments are possible, including alternately shaped beams and alternate agricultural tool mounting configurations, without deviating from the scope of the present invention.

Throughout this specification and claims which follow, unless the context requires otherwise, the word “comprise”, and variations such as “comprises” and “comprising”, will be understood to mean the inclusion of a stated feature or step, or group of features or steps, but not the exclusion of any other feature or step, or group of features or steps.

The reference to any prior art in this specification is not, and should not be taken as, an acknowledgement or any suggestion that the prior art forms part of the common general knowledge.

1. A head for attaching an agricultural tool to a support beam configured to be towed along a longitudinal axis, the support beam extending substantially transversely to the longitudinal axis, said head including:
a mounting bracket assembly configured to:
mount to the support beam at a location along a length of the support beam, and
enable attachment of the agricultural tool such that the agricultural tool, when attached, suspends from the clamped mounting bracket assembly,
the mounting bracket assembly being mountable to the support beam such that a tool attachment portion of the mounting bracket assembly is forwardly disposed, enabling the agricultural tool to be attached at a fore or central position along the longitudinal axis relative to the transverse support beam, or rearwardly disposed, enabling the agricultural tool to be attached at the central or an aft position along the longitudinal axis relative to the transverse support beam.

2. A head according to claim 1, wherein the support beam includes a first and a second edge substantially along its length and the mounting bracket assembly is configured to clamp one or both of the first and second edges to thereby fix the mounting bracket assembly at said location, the support beam including a horizontal dimension whereby the first edge is a leading edge of the support beam and the second edge is a trailing edge of the support beam.

3. A head according to claim 1, wherein the support beam includes a first and a second edge substantially along its length to which the mounting bracket assembly is configured to be attached, the support beam including a vertical dimension whereby the first edge is an upper edge of the support beam and the second edge is a lower edge of the support beam.

4. (canceled)

5. A head according to claim 3, wherein the mounting bracket assembly further includes:
a mounting bracket that enables attachment of the agricultural tool and that engages with one of the leading and trailing edges of the support beam, and
a clamping bracket that engages with the other of the leading and trailing edges of the support beam to thereby clamp, with the mounting bracket, the leading and trailing edges of the support beam.

6. A head according to claim 5, wherein the mounting bracket includes an inverted U-shape along its cross section formed by two spaced apart and substantially vertical wall flange portions and an upper web portion.

7. A head according to claim 6, wherein the upper web portion includes a first hook means for engaging with said one of the leading and trailing edges of the support beam, and the clamping bracket includes a second hook means for engaging with said other of the leading and trailing edges of the support beam, wherein the first hook means includes two transversely spaced apart slots configured to receive said one of the leading and trailing edges of the support beam, and wherein the second hook means associated with the clamping bracket includes two transversely spaced apart slots that are longitudinally separated from the spaced apart slots associated with the first hook means and configured to receive said other of the leading and trailing edges of the support beam.

8. (canceled)

9. (canceled)

10. A head according to claim 7, wherein the mounting bracket is configured such that when the first hook means is engaged with one of the leading or trailing edges of the support beam, the mounting bracket is caused to suspend from and is thereby supported by the support beam to facilitate use of the clamping bracket to engage with the other of the leading and trailing edges of the support beam.

11. A head according to claim 10, wherein the upper web element further includes a means of fastening the clamping bracket to the mounting bracket, the fastening means configured such that fastening of the clamping bracket causes the clamping bracket and hence the second hook means to move longitudinally towards the first hook means, and wherein sufficient fastening causes said other of the leading and trailing edges to be received in the transversely spaced apart slots associated with the second hook means, wherein the means of fastening the clamping bracket to the mounting bracket is in the form of a vertical fastening plate associated with the upper web element of the mounting bracket and which extends transversely between the two wall flange portions, the fastening plate including an aperture for engaging with a bolt associated with the clamping bracket, wherein tightening of the bolt causes said fastening of the clamping bracket to the mounting bracket and movement of the second hook means towards the first hook means.

12. (canceled)

13. A head according to claim 11, wherein after each of the leading and trailing edges are received in the corresponding slots associated with the first and second hook means, but prior to a full tightening of the bolt to fix the clamping bracket to the mounting bracket, the head is slideable along the support beam and thereby capable of being moved to and fixed at any desired location along the transverse support beam.

14. A head according to claim 6, wherein the two spaced apart and substantially vertical wall flange portions of the mounting bracket, or components associated therewith, are configured to support the agricultural tool in said fore or central position when the mounting bracket is mounted in a forwardly disposed configuration, or in said central or aft position when the mounting bracket is mounted in a rearwardly disposed configuration, and include means for fastening the agricultural tool at each of said positions, wherein the mounting bracket includes multiple fastening locations along or parallel to said longitudinal axis that enables the agricultural tool to be fastened at any one of the multiple locations.

15. (canceled)

16. A head according to claim 6, wherein the agricultural tool is a tine including a tine shank and associated components including a tine pivot pin about which the tine shank pivots and a spring or hydraulic cylinder for controlling an amount of breakout force on the tine shank, wherein the two vertical wall flange portions accommodate and include means for fastening the spring or hydraulic cylinder and the tine pivot pin therebetween.

17. A head according to claim 6, wherein the mounting bracket assembly includes:
a first mounting bracket that engages with one of the leading and trailing edges of the support beam,
a second mounting bracket connected to the first mounting bracket wherein the second mounting bracket enables attachment of the agricultural tool, and
a clamping bracket that engages with the other of the leading and trailing edges of the support beam to thereby clamp, with the first mounting bracket, the leading and trailing edges of the support beam,
wherein the second mounting bracket includes first and second transversely spaced apart plates attached to, and nestled inside, each respective wall flange portion associated with the first mounting bracket.

18. (canceled)

19. A head according to claim 17, wherein the two spaced apart plates of the second mounting bracket, or components associated therewith, are configured to support the agricultural tool in said fore or central position when the mounting bracket is mounted in a forwardly disposed configuration, or in said central or aft position when the mounting bracket is mounted in a rearwardly disposed configuration, and include means for fastening the agricultural tool at each of said positions, wherein the second mounting bracket includes multiple fastening locations along or parallel to said longitudinal axis that enables the agricultural tool to be fastened at any one of the multiple locations.

20. (canceled)

21. A head according to claim 1, wherein the agricultural tool is suitable for one or more of:
cultivating soil,
seeding, and
fertilizing.

22. A support beam including one or more mounted heads configured in accordance with claim 1, a substantially horizontal clamping plate that extends the length of the support beam and defines said first and second edge of the support beam, and side walls that stand substantially upright from the clamping plate.

23. (canceled)

24. (canceled)

25. A support beam according to claim 22, wherein the clamping plate and/or the upright side walls house additional components, and additional fastening means for attaching the additional components, the additional components including one or more of:
hydraulic hoses,
seed delivery hoses,
liquid and granular fertiliser delivery hoses,
electrical or isobus cables,
sensors,
wheels,
drawbar attachment,
connecting beams for connecting the support beam to an additional support beam, and
hydraulic cylinders, including hydraulic cylinders for facilitating folding of a winged portion of the support beam.

26. (canceled)

27. A support beam according to claim 22, wherein the support beam includes a plurality of forwardly and/or rearwardly mounted heads such that the agricultural tools, when attached to the heads, are aligned along at least two rows including:
a first row associated with the fore position and a second row associated with the central position; or
a first row associated with the fore position and a second row associated with the aft position; or
a first row associated with the central position and a second row associated with the aft position.

28. A support beam according to claim 22, wherein the support beam includes a plurality of forwardly and/or rearwardly mounted heads such that the agricultural tools, when attached to the heads, are aligned along three rows including a first row associated with the fore position, a second row associated with the central position, and a third row associated with the aft position.

29. A self-propelled agricultural machine or frame thereof including one or more support beams configured in accordance with claim 22.

30. A self-propelled agricultural machine or frame thereof according to claim 29, wherein the agricultural machine or frame thereof includes one of said support beams and a plurality of heads associated therewith such that the agricultural tools, when attached to the heads, are arranged in a single row, two rows or three rows, or the agricultural machine or frame thereof includes two or more of said support beams located at spaced apart intervals along said longitudinal axis and a plurality of heads associated with each support beam such that the agricultural tools, when attached to the heads, are arranged in a single row, two rows or three rows.

31. (canceled)
